(19) United States
(12) Patent Application Publication
(10) Pub. No.: US 2006/0026608 A1
(43) Pub. Date: Feb. 2, 2006

(54) Disc drive

(75) Inventor: Hsien-Tsung Chiu, Taoyuan County (TW)

Correspondence Address: BIRCH STEWART KOLASCH & BIRCH, PO BOX 747, FALLS CHURCH, VA, 22040-0747, US

(73) Assignee: BENQ CORPORATION

(21) Appl. No.: 11/175,437

(22) Filed: Jul. 7, 2005

(30) Foreign Application Priority Data
Jul. 27, 2004 (TW) 93122398

(51) Int. Cl. G11B 17/04; G11B 17/03; G11B 33/02

(52) U.S. Cl. 720/603

(57) ABSTRACT

A disc drive includes a loader, a tray, a base, an OPU, and a restraining element. The base and the tray are movably disposed on the loader respectively. The OPU is movably disposed on the base. The restraining element is detachably disposed on the tray. When the disc drive is closed (the tray is in the disc drive), the restraining element substantially holds the OPU at a first position.

### BACKGROUND

The invention relates to a disc drive capable of preventing random movement of an optical pick-up unit (OPU).

Compact Discs are commonly used to store digital data, such as movies, text, and images. When a disc is loaded in a disc drive, an OPU thereof emits laser light on the surface of the disc to access data recorded thereon. Thus, the OPU is a critical component in the disc drive.

Typically, disc drives are packaged in cartons and surrounded by protective material for shipping. Without specific protection, the OPU may randomly move due to sudden and violent movement during shipping. In such cases, the OPU may be damaged by collision with other components.

### SUMMARY

A disc drive is provided. An exemplary embodiment of a disc drive comprises a loader, a tray, a base, an OPU, and a restraining element. The tray and the base are movably disposed on the loader respectively. The OPU is movably disposed on the base. The restraining element is detachably disposed on the tray. When the disc drive is closed, the tray is in the disc drive, and the restraining element limits the OPU substantially at a first position.

Another exemplary embodiment of a disc drive comprises a loader, a tray, a base, at least a guide bar, an OPU, and a restraining element. The tray is movably disposed on the loader for accommodating a disc. The base is movably disposed on the loader. The guide bar is mounted on the base. The OPU is movably disposed between a first position and a second position on the guide bar to access the disc. The restraining element is detachably disposed on the tray. When the disc drive is closed, the OPU is at the first position, and the restraining element is on a path of the OPU to limit the OPU substantially at the first position and prevent the OPU from moving to the second position.

### DESCRIPTION OF THE DRAWINGS

Disc drives can be more fully understood by reading the subsequent detailed description and examples with references made to the accompanying drawings, wherein:

FIG. 1a is a diagram of an embodiment showing an open disc drive.

FIG. 1b is a diagram showing that the disc drive in FIG. 1a is closed.

FIG. 2a is a 3-D diagram showing a restraining element of an embodiment of a disc drive, wherein the restraining element is not disposed on a tray.

FIG. 2b is a 3-D diagram showing the restraining element in FIG. 2a disposed on the tray.

FIG. 2c is a 3-D diagram showing the bottom of the restraining element in FIG. 2a.

FIG. 3a is a 3-D diagram showing another restraining element of an embodiment of a disc drive, wherein the restraining element is not disposed on a tray.

FIG. 3b is a 3-D diagram showing the restraining element in FIG. 3a disposed on the tray.

### DETAILED DESCRIPTION

Embodiments of the invention provide a restraining element on a path of an optical pick-up unit (OPU) to limit the OPU substantially at a specific position, which prevents random movement of the OPU and the potential damage therefor.

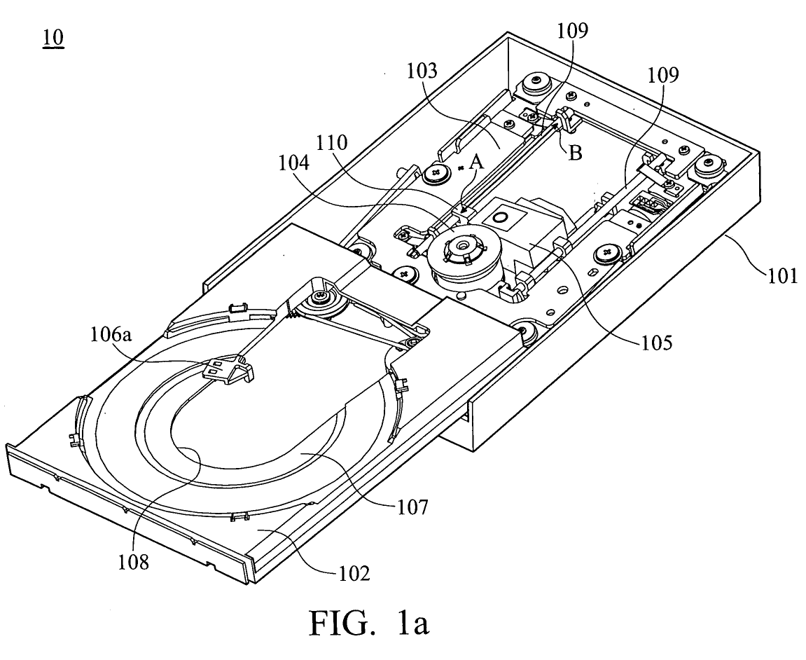

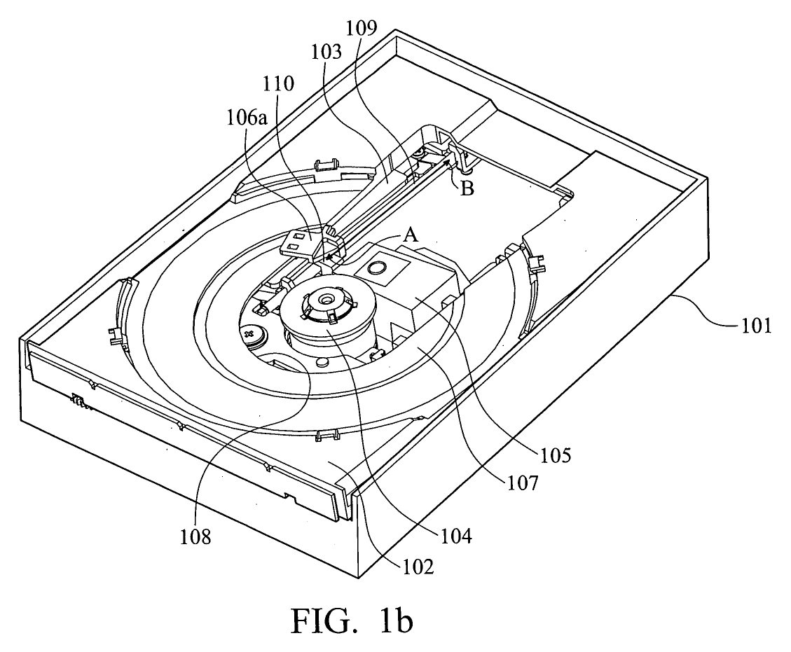

FIG. 1a is a diagram of an embodiment showing a disc drive 10 which is open. FIG. 1b is a diagram showing that the disc drive 10 in FIG. 1a is closed. In FIG. 1a, the disc drive 10, capable of preventing random movement of an optical pick-up unit (OPU), includes a loader 101, a tray 102, a base 103, at least a guide bar 109, an OPU 105, a rotator 104, and a restraining element 106a. The tray 102, disposed on the loader 101, can move forward and backward thereon. The tray 102 includes a recess 107 with an opening 108 for accommodating a disc (not shown) . The base 103, disposed on the loader 101, can move upward and downward thereon. The guide bar 109 is mounted on the base 103. The OPU 105 includes a connection portion 110 slidably mounted on the guide bars 109. The rotator 104 is disposed on the base 103 for rotating the disc when the OPU 105 accesses the disc. The restraining element 106a is detachably disposed near the opening 108 and projects from the recess 107. Thus, the disc can not be evenly placed in the recess 107, which may remind a user to remove the restraining element 106a before using the disc drive 10.

It is well-known to people in this art that during the usage of disc drive 10, the base 103 lowers down first, then the tray 102 moves out of the disc drive 10, i.e. the disc drive 10 is open. Due to the drop of the base 103, the restraining element 106a will be out of the path of the OPU 105 and move with the tray 102. User can place the disc in the recess 107 after removing the restraining element 106a from the recess 107. After the tray 102 moves into the disc drive 10, i.e. the disc drive 10 is closed, the base 103 moves upward so that the rotator 104 extends through the opening 108 of the recess 107 to rotate the disc, and the OPU 105 can access the disc by moving back and forth between a position A and a position B.

As shown in FIG. 1b, during shipping, the disc drive 10 is closed with no disc, the OPU 105 is at the position A adjacent to the rotator 104, and the restraining element 106a is disposed on the path of the OPU 105. Detailed speaking, the restraining element 106a disposed on the recess 107 near the opening 108 is adjacent to and behind the connection portion 110 to limit the OPU 105 substantially at a first position, such as the position A, and prevent the OPU 105 from moving to a second position, such as the position B. In brief, the restraining element 106a on the path of the OPU 105, i.e. between positions A and B, limits the OPU 105 substantially at a first position to prevent random movement of the OPU 105 and the potential damage therefor.

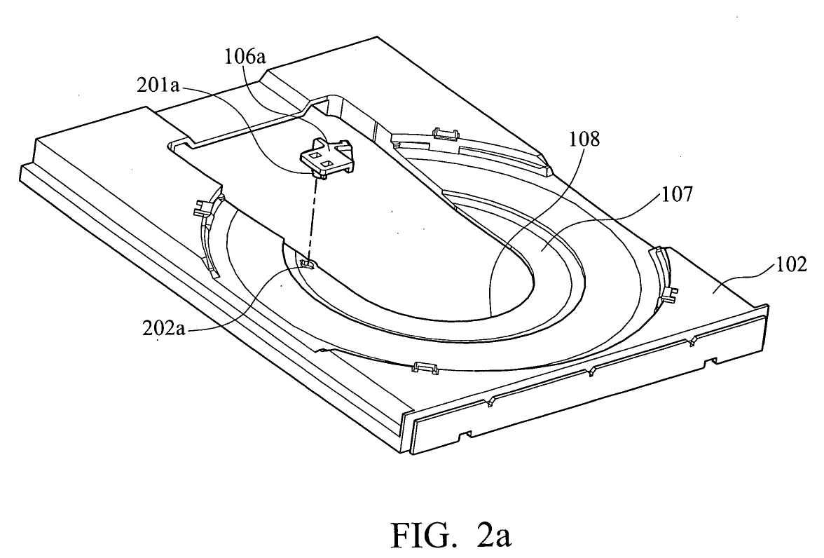

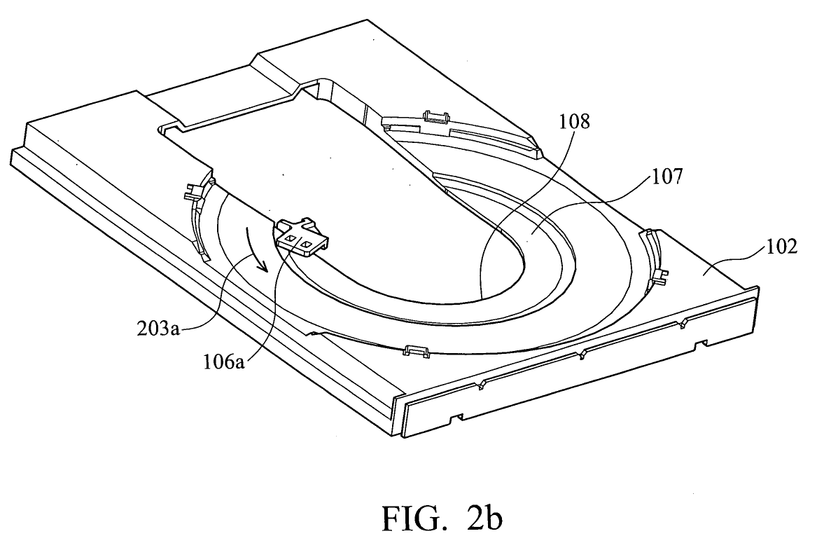

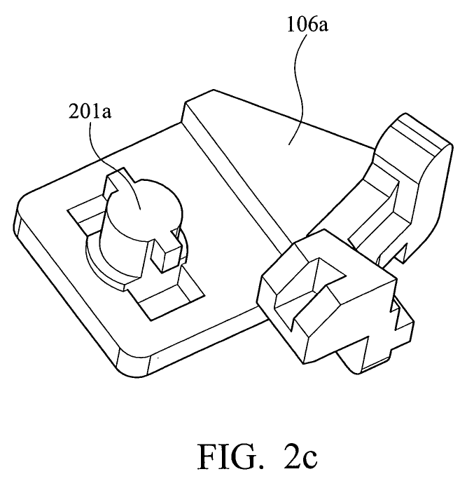

FIG. 2a and FIG. 2b are 3-D diagrams about the restraining element 106a and the tray 102 in an embodiment of a disc drive. FIG. 2c shows the bottom of the restraining element 106a in FIG. 2a and FIG. 2b.

The restraining element 106a includes a first engaging portion. The tray 102 includes a second engaging portion corresponding to the first engaging portion. The restraining element 106a is disposed on the tray 102 by engaging the first engaging portion with the second engaging portion.

As shown in FIGS. 2a-2c, the first engaging portion is a male, specifically a T-shaped protrusion 201a herein. Correspondingly, the second engaging portion is a female, specifically a T-shaped hole 202a. It is noted that in another embodiment, the first engaging portion may be a female, and the second engaging portion may be a male.

By inserting the T-shaped protrusion 201a into the T-shaped hole 202a and rotating the T-shaped protrusion 201a along the arrow 203a in FIG. 2b with an appropriate angle, the restraining element 106a is deposed on the tray 102. Conversely, the restraining element 106a can be detached by rotating in reverse direction.

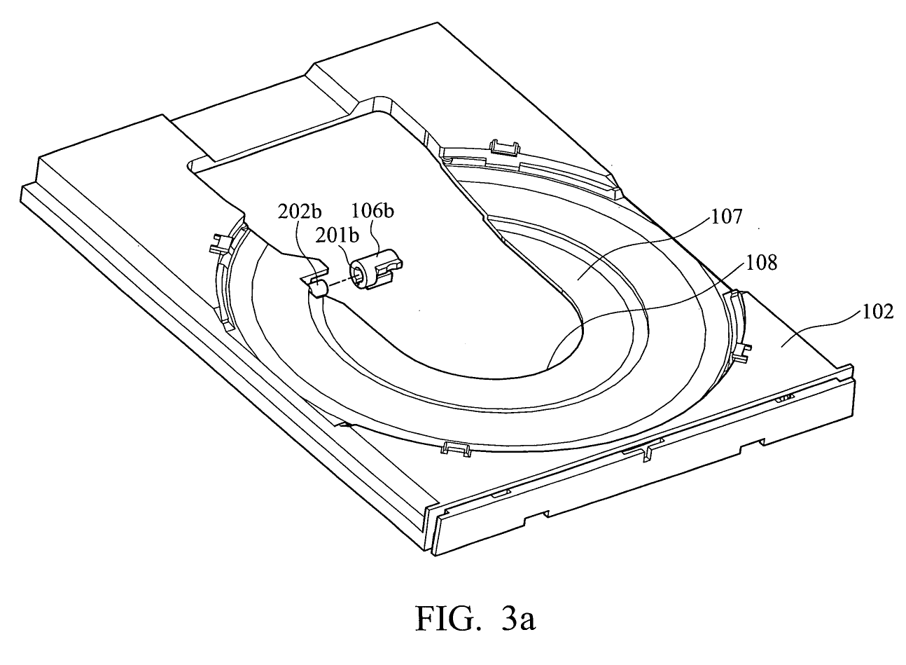

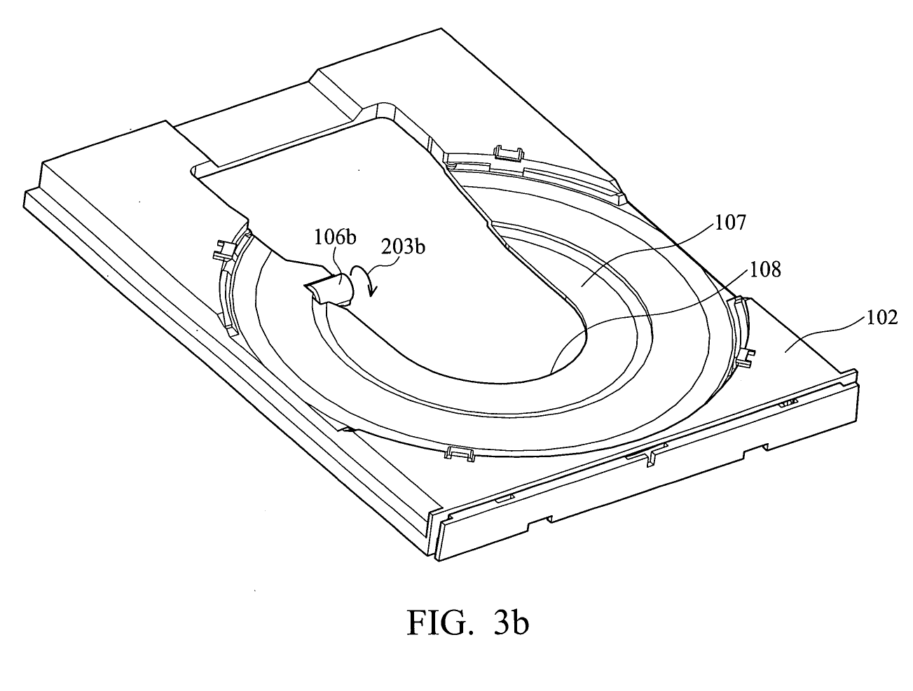

The restraining element of embodiments of the invention and the corresponding portion of the tray thereof can be design to other shapes. FIG. 3a and FIG. 3b are 3-D diagrams about the restraining element 106b and the tray 102 in another embodiment of a disc drive. The first engaging portion of the restraining element 106b is a female, the hole 201b, and the second engaging portion of the tray 102 is a male corresponding thereto, the protrusion 202b. It should be understood that in this embodiment, the protrusion 202b is below the recess 107. By covering the round protrusion 202b and rotating an appropriate angle along the arrow 203b in FIG. 3b, the restraining element 106b is disposed on the tray 102. Conversely, the restraining element 106b can be detached by rotating in reverse direction.

In embodiments of the invention, an OPU can be limited substantially at a specific position by disposing a restraining element on a path of the OPU, which prevents random movement of the OPU during shipping and the potential damage therefor.

While the invention has been described by way of example and in terms of several embodiments, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A disc drive, comprising:
a loader;
a tray movably disposed on the loader;
a base disposed on the loader;
an OPU movably disposed on the base; and
a restraining element detachably disposed on the tray;
wherein when the disc drive is closed, the tray is in the disc drive and the restraining element limits the OPU substantially at a first position.

2. The disc drive as claimed in claim 1, wherein the tray includes a recess with an opening for accommodating a disc, and the restraining element is detachably disposed on the recess near the opening.

3. The disc drive as claimed in claim 2 further comprising a rotator disposed on the base, wherein when the disc drive is closed, the rotator extends through the opening of the recess.

4. The disc drive as claimed in claim 3, wherein the restraining element holds the OPU near the rotator.

5. The disc drive as claimed in claim 1, wherein the restraining element includes a first engaging portion, the tray includes a second engaging portion corresponding thereto, and the restraining element is disposed on the tray by engaging the first engaging portion with the second engaging portion.

6. The disc drive as claimed in claim 5, wherein the first engaging portion is a female, and the second engaging portion is a male.

7. The disc drive as claimed in claim 5, wherein the first engaging portion is a male, and the second engaging portion is a female.

8. The disc drive as claimed in claim 5, wherein the first engaging portion is rotatably engaged with the second engaging portion.

9. The disc drive as claimed in claim 8, wherein the first engaging portion is a T-shaped protrusion, the second engaging portion is a T-shaped hole, and the restraining element is disposed on the tray by inserting the T-shaped protrusion into the T-shaped hole and rotating the T-shaped protrusion with an angle.

10. A disc drive, comprising:
a loader;
a tray movably disposed on the loader for accommodating a disc;
a base movably disposed on the loader;
at least a guide bar mounted on the base;
an OPU movably disposed between a first position and a second position on the guide bar to access the disc; and
a restraining element detachably disposed on the tray;
wherein when the disc drive is closed, the OPU is at the first position, and the restraining element is on a path of the OPU to limit the OPU substantially at the first position and prevent the OPU from moving to the second position.

11. The disc drive as claimed in claim 10 further comprising a rotator disposed on the base for rotating the disc when the OPU accesses the disc.

12. The disc drive as claimed in claim 11, wherein the OPU includes a connection portion slidably mounted on the guide bar, and when the disc drive is closed, the OPU is adjacent to the rotator, and the restraining element is behind the connection portion to limit the OPU substantially at the first position.

13. The disc drive as claimed in claim 10, wherein when the tray moves out of the disc drive, the base lowers down, the restraining element is out of the path and moves with the tray.

14. The disc drive as claimed in claim 10, wherein the tray includes a recess for accommodating the disc, and the restraining element is detachably disposed on the recess.

15. The disc drive as claimed in claim 10, wherein the restraining element includes a first engaging portion, the tray includes a second engaging portion corresponding thereto, and the restraining element is disposed on the tray by engaging the first engaging portion with the second engaging portion.

16. The disc drive as claimed in claim 15, wherein the first engaging portion is a female, and the second engaging portion is a male.

17. The disc drive as claimed in claim 15, wherein the first engaging portion is a male, and the second engaging portion is a female.

18. The disc.drive as claimed in claim 15, wherein the first engaging portion is rotatably engaged with the second engaging portion.

19. The disc drive as claimed in claim 18, wherein the first engaging portion is a T-shaped protrusion, the second engaging portion is a T-shaped hole, and the restraining element is disposed on the tray by inserting the T-shaped protrusion into the T-shaped hole and rotating the T-shaped protrusion with an angle.
